(19) United States
(12) Patent Application Publication
(10) Pub. No.: US 2011/0060815 A1
(43) Pub. Date: Mar. 10, 2011

(54) AUTOMATIC ATTACHMENT OF SERVER HOSTS TO STORAGE HOSTGROUPS IN DISTRIBUTED ENVIRONMENT

(75) Inventor: Edward J. Batewell, Bentonville, AR (US)

(73) Assignee: INTERNATIONAL BUSINESS MACHINES CORPORATION, Armonk, NY (US)

(21) Appl. No.: 12/555,851

(22) Filed: Sep. 9, 2009

(51) Int. Cl. G06F 15/177

(52) U.S. Cl. 709/221

(57) ABSTRACT

A system, method and program product for for automatically configuring a storage device for a server. A method is provided that includes:preconfiguring the storage device with a set of LUNs and a hostgroup; preconfiguring the server to include a storage configuration package; connecting the storage device to the server; launching the storage configuration package on the server to run a set of scripts to perform the actions comprised of: installing a set of drivers; resetting a UUID and modifying a kernel; installing a storage management system on the server; discover WWIDs, a hostname and the storage device; create and add the hostname to the hostgroup; and pass the WWIDs to the storage device; and mapping a set of disks; and rebooting the computer.

### FIELD OF THE INVENTION

This disclosure is related to configuring storage in a distributed environment, and more particularly to a solution for configuring a server to automatically use external storage.

### BACKGROUND OF THE INVENTION

In many distributed enterprise environments, such as large scale retail operations, server and storage devices utilized at different locations must be regularly modified or upgraded to meet changing technological and business demands. To implement such a process, servers and/or storage devices may often be preconfigured at a remote location and shipped to a site for implementation. Unfortunately, servers and associated storage devices require significant manual intervention to be set up. In a retail operation, there typically may be little or no IT support to handle the necessary procedures. As such, significant costs can be incurred when storage and/or server upgrades are required.

In a typical scenario, an administrator must remotely log into a server, utilize a storage manager to contact the storage, and map host (i.e., server) world wide identifiers (WWIDs) to waiting preconfigured logical unit numbers (LUNs) within the storage. Unfortunately, this requires the expertise of an administrator, as well as a fully functioning network.

### SUMMARY OF THE INVENTION

Disclosed is a method, system and program product that allows one or more hosts to be automatically configured to “claim” a shared storage device (such as an IBM DS3000 Series storage system). The automation provides a single scripting solution that can run without modification on any number of hosts, regardless of their name, specific hardware identifiers, or other unique attributes.

In a first aspect, the invention provides a method for automatically configuring a storage device for a host, comprising: preconfiguring the storage device with a set of LUNs and a hostgroup; preconfiguring the host to include a storage configuration package; connecting the storage device to the host; and launching the storage configuration package on the host to run a set of scripts to perform the actions comprised of: installing a set of drivers; resetting a UUID (universally unique identifier) and modifying a kernel; installing a storage management system on the host; discovering WWIDs, a hostname and the storage device; creating and adding the hostname to the hostgroup; passing the WWIDs to the storage device, and associating the WWIDs with the host; mapping a set of disks; and rebooting the host.

In a second aspect, the invention provides a system for automatically configuring a storage device for a host, comprising: a system for automatically installing a set of drivers on a host; a system for automatically resetting a UUID and modifying a kernel; a system for automatically installing a storage management system on the host; a system for automatically discovering WWIDs, a hostname and the storage device; automatically creating and adding the hostname to the hostgroup; and for automatically passing the WWIDs to the storage device; and a system for automatically mapping a set of disks and rebooting the host.

In a third aspect, the invention provides a computer readable storage medium having a program product stored thereon for automatically configuring a host for a storage device, which when executed by a computer system includes: program code for automatically installing a set of drivers on a host; program code for automatically resetting a UUID and modifying a kernel; program code for automatically installing a storage management system on the host; program code for automatically discovering WWIDs, a hostname and the storage device; for automatically creating and adding the hostname to the hostgroup; and for automatically passing the WWIDs to the storage device; and program code for automatically mapping a set of disks and rebooting the host.

In a fourth aspect, the invention provides a method for deploying a system for automatically configuring a host for a storage device, comprising: providing a computer infrastructure being operable to: automatically install a set of drivers on a host; automatically reset a UUID and modify a kernel; automatically install a storage management system on the host; automatically discover WWIDs, a hostname and the storage device; automatically create and add the hostname to the hostgroup; automatically pass the WWIDs to the storage device; and automatically map a set of disks and reboot the host.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings.

FIG. 1 depicts a storage architecture in accordance with an embodiment of the present invention.

FIG. 2 depicts a flow diagram of a method in accordance with an embodiment of the present invention.

FIG. 3 depicts a computer system having a storage configuration package in accordance with an embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

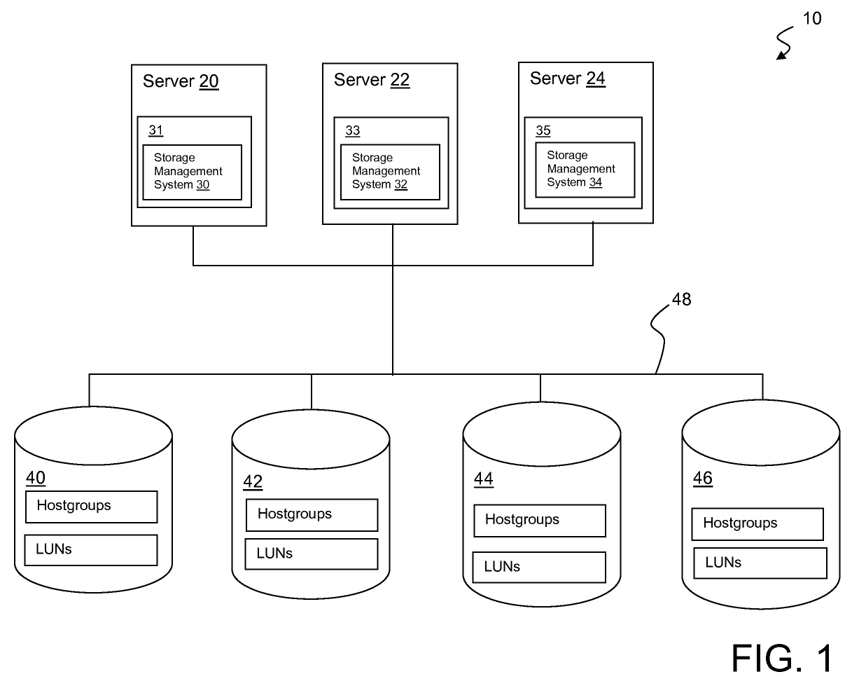

FIG. 1 depicts an illustrative distributed storage architecture 10 that includes a set of servers 20, 22, 24 and a set of storage devices 40, 42, 44, 46. Note that for the purposes of this disclosure, the term server and host are used interchangeably. The servers 20, 22, 24 and storage devices 40, 42, 44, 46 are connected via a link 48 that includes both an in-band (i.e., direct) connection and a switched (i.e., network) connection. The present solution provides an approach that allows new storage devices and hosts to be added with a simple push button option that allows an unskilled user to configure a host to recognize and use a new storage device.

Prior to installation, each storage device 40, 42, 44, 46 is preconfigured with one or more LUNs and one or more empty hostgroups, in which the empty hostgroup owns the associated LUNs. LUNs are storage settings that present a group of disks to a host as a single logical drive. The term hostgroup refers to the group of hosts that are to be granted access to shared LUNs on the storage device. Hostname refers to the name assigned to a host. Because prior to installation of a given storage device it is unknown which hosts will make up the hostgroup, the hostgroup is initially configured as empty. Each server 20, 22, 24 is preconfigured with a storage configuration package 31, 33, 35, respectively, that automatically configures storage, discovers WWIDs (world wide identifiers), adds the host to the empty hostgroup, and installs a storage management system 30, 32, 34 on the server. Storage management systems are known in the art for managing distributed storage devices. However, existing storage management systems typically require a separate dedicated computer/server within the architecture. In the present embodiment, once deployed, each server is has its own storage management system 30, 32, 34 capable of managing the storage devices 40, 42, 44, 46. This eliminates the need for a dedicated computer/server to manage the storage.

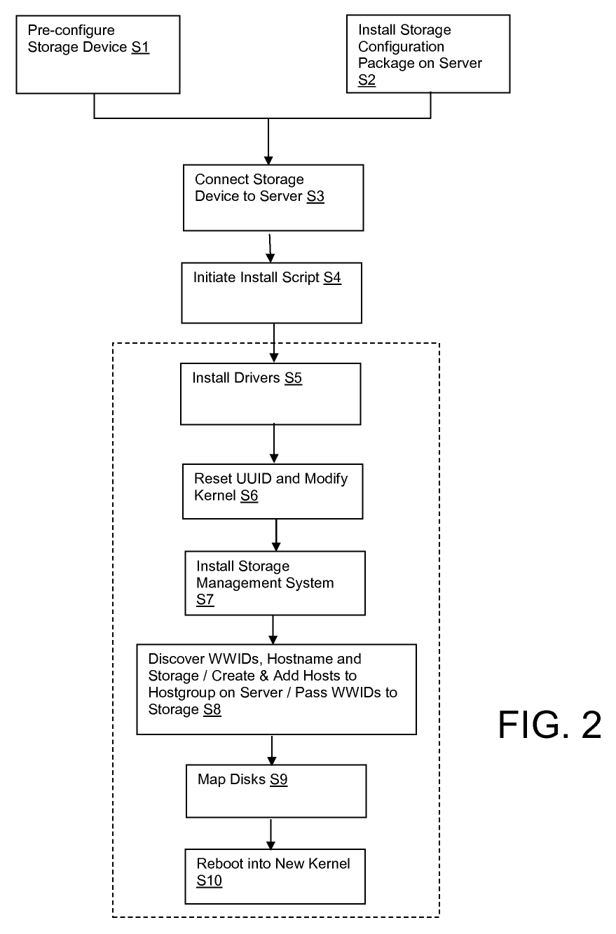

FIG. 2 depicts a flow diagram showing a method for providing the automation described above. At S1, a storage device is preconfigured with a set of LUNs and one or more empty hostgroups. At S2, the host (i.e., server) is preconfigured with a storage configuration package. At S3, the host and storage device are shipped to a site where the storage device is connected to the server. As described, the configuration process is done in-band, so that a working network connection is not required. At S4, an install script is initiated by a user at the site. This may be as simple as the user turning on the server and responding to a question “Do you want to configure new storage?”

Once the script is initiated, a number of actions occur outlined in S5-S10. Note that the description that follows utilizes examples described in a Linux environment. However, it is understood that the invention is not limited to a particular operating system or environment, and that the examples that follow are for describing an illustrative embodiment. In this example, the files and scripts for performing the actions may be stored in a tarball (i.e., zipfile), and extracted during a pre-script sanity check. At S5, drivers are extracted and installed, which allows, for example, the host to talk to the storage device over dual paths. In addition, at S6, UUIDs (universally unique identifiers) are reset and the kernel is modified by creating a ramdisk image that will load the driver modules. Also, the boot menu is rewritten to facilitate booting into the new, modified kernel. Next, at S7, the storage management system is installed, which will permit the host to make additions and changes to the storage devices for purposes of installation, and later, administration.

At S8, WWIDs, hostnames and storage devices are discovered; the host claims its membership in storage hostgroups, passing its name to the storage device; and host WWIDs are passed to the storage device, which associate WWIDs with a host. A dual port SAS daughter card has two WWIDs which are unique identifiers of ports on the host's storage controller. There are several ways of discovering WWIDs. For example, in an IBM BladeCenter environment, the Advanced Management Module (AMM) can report this data. If there is no network connectivity to a remote AMM, then the Linux file system can be used to report the WWIDs.

Note that the above two examples are contingent upon the location of the card on the PCI bus, or upon the ioc#. Another, more portable possibility is for a program such as LSlutil to discover WWIDs, which is host-based, and works independently of the card's location on a PCI bus. In this example, a process determines the type of host, Isiutil is run, a script takes the output of LSlutil and parses the text for the “SAS WWID”, and based upon what LSlutil returns and the type of host detected, increments appropriately to set the desired WWIDs as variables. Next, the name of the host (i.e., its hostname) is discovered using operating system commands, and is set as a variable.

Next, the storage device is discovered in-band through the storage connections, in one example SAS cables, rather than out-of-band over IP. Managing the storage in this way eliminates dependency on the network and all of its layers, management, staff, etc., and enables the owner of the host to manage their own storage. All communication between individual hosts and storage will be conducted in-band for the duration of the installation procedure. Assuming the enclosure has been cabled properly and the SAS switches have been zoned correctly, a command can be issued to discover the storage enclosures and establish communications between hosts and storage.

Next, hosts are added to an existing hostgroup on the storage device. As noted, the storage device has already been carved up with the LUNs allocated to hostgroups. In this example, the hostgroup name has been hardcoded, and its drives are laid out appropriately for the virtual machines that will use them. The storage management system is scripted to make the storage device aware of the hosts' storage devices, and using the discovered hostname, adds the hostname to the existing hostgroups.

Next, WWIDs are passed to the storage device using the storage management system where WWIDs are associated with the appropriate host. In this embodiment, the WWID variables discovered earlier using LSlutil are passed to the storage device to be associated with hosts. This thus allows the storage device to associate host volumes with a hostgroup name, instead of individual hostnames.

Once this is complete, disks are mapped at S9. A disk mapping service may be used to link newly discovered disks in /dev/disk/by-id to something more logical, by substituting logical names for the SCSI3 IDs. There are several ways to do this. One acceptable and highly flexible way is to add a service to /etc/init.d that may be called at any time (including at reboot) to discover disks and map them. This method will allow such a service to be called anytime (and particularly, at boot time) to discover newly allocated LUNs, and link them to logical names for the benefit of the administrator. Before rebooting, a command can be issued to copy useful items, e.g., LSlutil and other scripts, and clean up the install bits.

Finally, at S10, a reboot is done into the modified kernel. The disks will not be seen properly until it is rebooted into the new kernel with multipath modules loaded. The host is then rebooted into the modified kernel. Upon reboot, the host runs the LUN discovery and mapping method, and enters production.

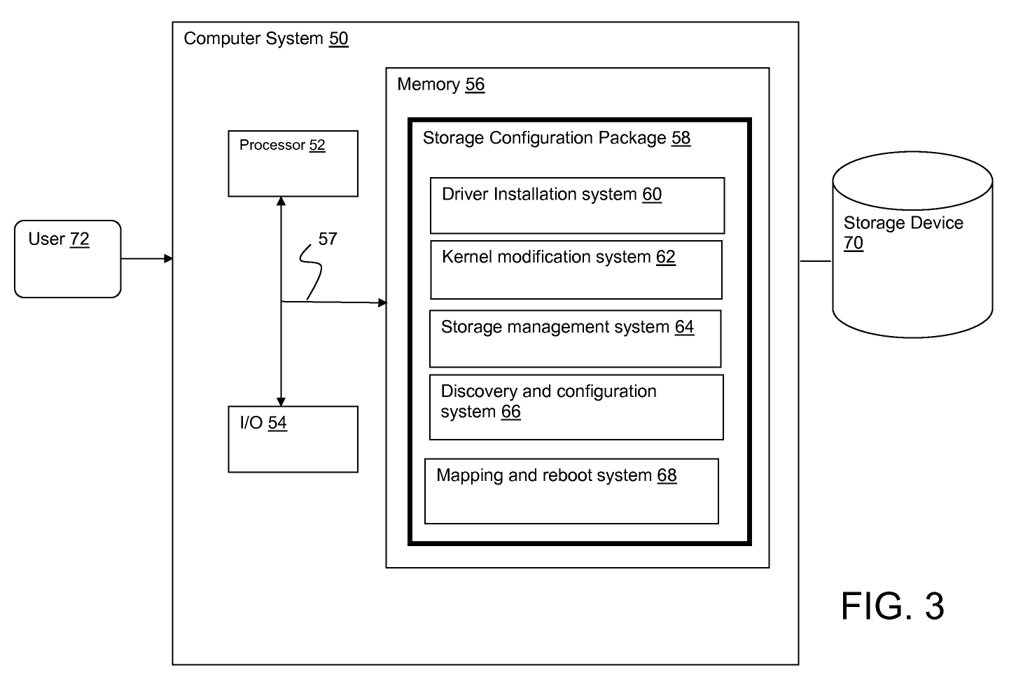

Referring now to FIG. 3, a computer system 50 is shown with a storage configuration package 58 for allowing a user 72 to automatically configure computer system 50 with storage device 70. In this embodiment, computer system 50 generally comprises a server/host, such as a blade in a distributed storage environment.

As shown, storage configuration package 58 is stored in memory 56 and may be implemented as a computer program product (i.e., software program, script, combination thereof, etc.). Storage configuration package 58 generally includes: (1) a driver installation system 60 for installing the necessary drivers for allowing computer system 50 to speak with storage device 70; (2) a kernel modification system for resetting UUIDs and modifying the operating system kernel of the computer system 50; (3) a storage management system 64 that is installed within the computer system 50 for managing storage device 70; (4) a discovery and configuration system 66 that discovers WWIDs, hostnames and storage, creates and adds the hostname to the hostgroup, and passes WWIDs to the storage device; and (5) a mapping and reboot system 68 for mapping drives and rebooting the computer system 50.

It is understood that computer system 50 may be implemented as any type of computing infrastructure/device. Computer system 50 generally includes a processor 52, input/output (I/O) 54, memory 56, and bus 57. The processor 52 may comprise a single processing unit, or be distributed across one or more processing units in one or more locations, e.g., on a client and server. Memory 16 may comprise any known type of data storage, including magnetic media, optical media, random access memory (RAM), read-only memory (ROM), a data cache, a data object, etc. Moreover, memory 16 may reside at a single physical location, comprising one or more types of data storage, or be distributed across a plurality of physical systems in various forms.

I/O 54 may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. Bus 57 provides a communication link between each of the components in the computer system 50 and likewise may comprise any known type of transmission link, including electrical, optical, wireless, etc. Although not shown, additional components, such as cache memory, communication systems, system software, etc., may be incorporated into computer system 50.

Access to computer system 50 may be provided over a network such as the Internet, a local area network (LAN), a wide area network (WAN), a virtual private network (VPN), etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

It should be appreciated that the teachings of the present invention could be offered as a business method on a subscription or fee basis. For example, a computer system 50 comprising a storage configuration package 58 could be created, maintained and/or deployed by a service provider that offers the functions described herein for customers. That is, a service provider could offer to deploy or provide the ability to automatically configure storage as described above.

It is understood that in addition to being implemented as a system and method, the features may be provided as a program product stored on a computer-readable storage medium, which when executed, enables computer system 50 to provide automated storage configuration. To this extent, the computer-readable storage medium may include program code (including scripts), which implements the processes and systems described herein. It is understood that the term “computer-readable storage medium” comprises one or more of any type of physical embodiment of the program code. In particular, the computer-readable storage medium can comprise program code embodied on one or more portable storage articles of manufacture (e.g., a compact disc, a magnetic disk, a tape, etc.), on one or more data storage portions of a computing device, such as memory 56 and/or a storage system.

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that terms such as “component” and “system” are synonymous as used herein and represent any combination of hardware and/or software capable of performing some function(s).

The block diagrams in the figures illustrate the architecture, functionality, and operation of possible implementations of systems, methods and computer program products according to various embodiments of the present invention. In this regard, each block in the block diagrams may represent a module, segment, or portion of code, which comprises one or more executable instructions for implementing the specified logical function(s). It should also be noted that the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams can be implemented by special purpose hardware-based systems which perform the specified functions or acts, or combinations of special purpose hardware and computer instructions.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A method for automatically configuring a storage device for a host, comprising:
preconfiguring the storage device with a set of LUNs (logical unit numbers) and a hostgroup;
preconfiguring the host to include a storage configuration package;
connecting the storage device to the host;
launching the storage configuration package on the host to run a set of scripts to perform the actions comprised of:
installing a set of drivers;
resetting a UUID (universally unique identifier) and modifying a kernel;
installing a storage management system on the host;
discovering WWIDs (world wide identifiers), a hostname and the storage device;
creating and adding the hostname to the hostgroup;
passing the WWIDs to the storage device, and associating the WWIDs with the host;
mapping a set of disks; and
rebooting the host.

2. The method of claim 1, wherein all communication between the host and storage device is performed in-band.

3. The method of claim 1, wherein the set of drivers allow the host to communicate with the storage device.

4. The method of claim 1, wherein the hostgroup is empty when the storage device is preconfigured.

5. The method of claim 1, wherein the storage management system is utilized to administer the storage device.

6. The method of claim 1, wherein the WWIDs comprise unique identifiers of ports on a storage controller of the host.

7. A system for automatically configuring a storage device for a host, comprising:
a system for automatically installing a set of drivers on a host;
a system for automatically resetting a UUID (universally unique identifier) and modifying a kernel;
a system for automatically installing a storage management system on the host;
a system for automatically discovering WWIDs (world wide identifiers), a hostname and the storage device;
a system for automatically creating and adding the hostname to the hostgroup, and for automatically passing the WWIDs to the storage device; and
a system for automatically mapping a set of disks and rebooting the host.

8. The system of claim 7, wherein all communication between the host and storage device is performed in band.

9. The system of claim 7, wherein the set of drivers allow the host to communicate with the storage device.

10. The system of claim 7, wherein the hostgroup is initially empty after the storage device is preconfigured.

11. The system of claim 7, wherein the storage management system is utilized to administer the storage device.

12. The system of claim 7, wherein the WWIDs comprise unique identifiers of ports on a storage controller of the host.

13. A computer readable storage medium having a program product stored thereon for automatically configuring a host for a storage device, which when executed by a computer system includes:
program code for automatically installing a set of drivers on a host;
program code for automatically resetting a UUID (universally unique identifier) and modifying a kernel;
program code for automatically installing a storage management system on the host;
program code for automatically discovering WWIDs (world wide identifiers), a hostname and the storage device;
program code for automatically creating and adding the hostname to the hostgroup and for automatically passing the WWIDs to the storage device; and
program code for automatically mapping a set of disks and rebooting the host.

14. The computer readable storage medium of claim 13, wherein all communication between the host and storage device is performed in-band.

15. The computer readable storage medium of claim 13, wherein the set of drivers allow the host to communicate with the storage device.

16. The computer readable storage medium of claim 13, wherein the hostgroup is initially empty after the storage device is preconfigured.

17. The computer readable storage medium of claim 13, wherein the storage management system is utilized to administer the storage device.

18. The computer readable storage medium of claim 13, wherein the WWIDs comprise unique identifiers of ports on a storage controller of the host.

19. A method for deploying a system for automatically configuring a host for a storage device, comprising:
providing a computer infrastructure being operable to:
automatically install a set of drivers on a host;
automatically reset a UUID and modify a kernel;
automatically install a storage management system on the host;
automatically discover WWIDs (world wide identifiers), a hostname and the storage device;
automatically create and add the hostname to the hostgroup;
automatically pass the WWIDs to the storage device; and
automatically map a set of disks and reboot the host.

20. The method of claim 19, wherein the hostgroup is initially empty.
